(19) United States
(12) Patent Application Publication
(10) Pub. No.: US 2009/0272088 A1
(43) Pub. Date: Nov. 5, 2009

(54) RECONFIGURABLE STAND-UP TRANSPORTATION APPARATUS

(76) Inventor: Paul Losey, Saline, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/434,214

(22) Filed: May 1, 2009

Related U.S. Application Data
(60) Provisional application No. 61/049,491, filed on May 1, 2008.

(51) Int. Cl. A01D 34/00

(52) U.S. Cl. 56/14.7

(57) ABSTRACT

A method of converting a stand-on type lawn mower into a non-mower implement includes the steps of removing the mower deck from the frame, leaving the engine, steering mechanism and steering controls substantially intact, and mounting components to the frame enabling the implement to be used for a non-mower application. The preferred embodiment includes the steps of mounting a dump bucket to the frame through a forward hinge, and providing an actuator with a user-operated control, the actuator being operative to pivot the dump bucket between a non-dump position for loading and transport and a dump position wherein the bucket is lifted through the forward hinge for dumping purposes. The actuator may be an electric linear actuator, and the user-operated control may be supported proximate to the steering controls.

### REFERENCE TO RELATED APPLICATION

This application claims priority from U.S. Provisional Patent Application Ser. No. 61/049,491, filed May 1, 2008, the entire content of which is incorporated herein by reference.

### FIELD OF THE INVENTION

This invention relates generally to single-person vehicles and, in particular, to a stand-up/stand-on transportation apparatus that can be reconfigured for numerous uses.

### BACKGROUND OF THE INVENTION

Stand-up lawnmowers can be very effective and versatile in some situations. Sometimes called stand-on or “set-on” vehicles, such mowers are available from various manufacturers, including Wright Commercial Products of Gaithersburg, Md. (under the “Stander” moniker), and others. Stand-up mowers are easy to mount and dismount, and if the controls are well engineered, maneuverability can be superior.

The stand-on configuration could be use to improve apparatus other than lawnmowers. U.S. Pat. No. RE33,131, for example, describes a motorized dump-type vehicle having a chassis frame, a gasoline engine mounted on the frame, a dump container pivotally mounted on the front of the frame, and a hydraulic system enabling the container to be raised and lowered. The vehicle can be driven in either forward or reverse directions and braked by hydraulic drive motors. The hydraulic fluid is cooled by an oil reservoir tank forming a structural part of the frame and positioned such that heat from the hydraulic fluid can dissipate itself in the container and its contents. The apparatus may adapted to a riding-step-type vehicle as illustrated in FIG. 5, reproduced herein as FIG. 1 (Prior Art). In this case there has been added a step platform 110 secured to chassis 12 and a conventional steering mechanism 132 having a steering wheel 114, a steering rod 115 and steering gear box 116 suitably connected through chain 117 to pivot rear wheel 50.

While this particular prior-art configuration does provide a step-on, motorized wheelbarrow, there are several problems with the design, not the least of which is the steering mechanism. The use of a steering wheel would severely limit the manipulability of such a vehicle, whether for dumping purposes or otherwise.

### SUMMARY OF THE INVENTION

This invention broadly resides in a method of converting a stand-on type lawn mower into a non-mower implement. It is assumed that the stand-on type lawn mower comes with a frame with a mower deck, engine, steering mechanism and steering controls. The inventive method includes the steps of removing the mower deck from the frame, leaving the engine, steering mechanism and steering controls substantially intact, and mounting components to the frame enabling the implement to be used for a non-mower application.

The preferred embodiment includes the steps of mounting a dump bucket to the frame through a forward hinge, and providing an actuator with a user-operated control, the actuator being operative to pivot the dump bucket between a non-dump position for loading and transport and a dump position wherein the bucket is lifted through the forward hinge for dumping purposes.

The actuator may be an electric linear actuator, and the user-operated control may be supported proximate to the steering controls. If the dump bucket has a bottom with a contour, the method preferably further includes the step of mounting a bucket support frame on the frame, such that the bucket support frame has an upper surface that cooperates with the bottom contour of the dump bucket.

Should the mower deck include a pair of opposing caster wheels attached thereto, the method may farther comprise the steps of temporarily removing the caster wheels from the mower deck, installing a mounting plate onto the frame once the mower deck is removed, and mounting the caster wheels to the mounting plate. A debris shield may be provided on the dump bucket or elsewhere to protect the engine from contamination during bucket loading.

### BRIEF DESCRIPTION OF THE DRAWINGS

FIG. 1 is a drawing taken from U.S. Pat. No. RE33,131, which shows a riding-step-type powered dumping vehicle;

FIG. 2 illustrates a stand-on power wheelbarrow, wherein a removable bucket is attached to a horizontal platform driven by a person standing at the rear of the unit;

FIG. 3A shows the configuration of FIG. 2 with the bucket 202 in the non-dump position for motorized transport;

FIG. 3B shown the bucket in the dump position, having pivoted about a hinge through activation of a user-operated control;

FIG. 4 illustrates a different application involving the same basic platform.

FIG. 5 shows a removable flat bed with sides that may also be removable;

FIG. 6 shows a flat bed with one or more rack portions;

FIG. 7 illustrates a trash collection application including a square container, which may have an open or a closed top;

FIG. 8 illustrates a vacuum embodiment of the invention including a suction head feeding a collection box;

FIG. 9 illustrates an embodiment wherein boats, trailers or other items attached to a tow hitch may be moved with the stand-on platform.

FIG. 10 illustrates a vending embodiment of the invention, for golf courses, fairs, parks and other environments;

FIG. 11 illustrates a park ranger implementation;

FIG. 12 illustrates a parking lot management application with accessories such as cameras, flashers, and other items unique to this application;

FIG. 13 illustrates a mail carrier for postal applications, with an optional transparent cover;

FIG. 14 illustrates a “meter maid” or other law-enforcement application;

FIG. 15 shows a higher level of security application, which may include flashers, mirrors, radios or other accessories;

FIG. 16 shows a “rickshaw” application; and

FIG. 17 illustrates a mobile light application, wherein the stand-on platform carries batteries or a fueled power unit to illuminate a portable light.

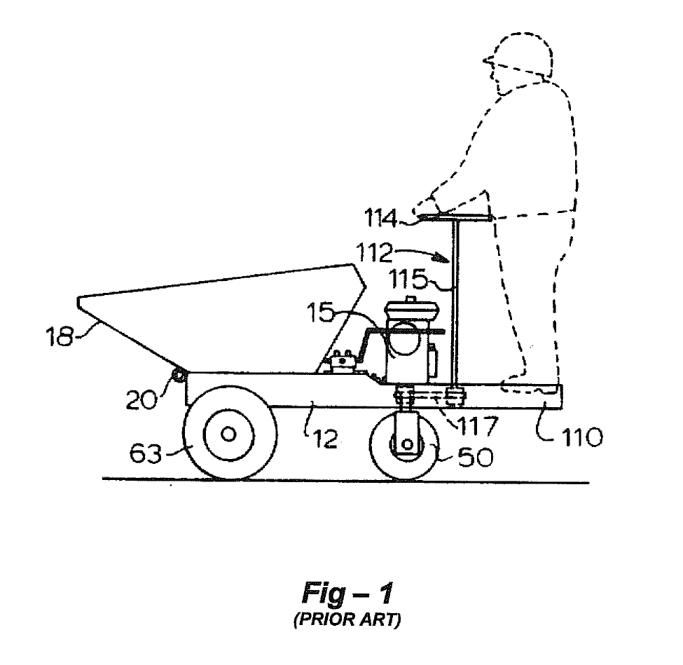

### DETAILED DESCRIPTION OF THE INVENTION

This invention exploits the maneuverability made possible by a powered, stand-on platform, enabling configurations other than riding mowers to be constructed. The preferred embodiment includes a horizontal platform with four or perhaps three wheels, and a rearward portion upon which a “driver” stands to guide the platform. According to the invention, commercially available powered platforms may be converted for the purposes described herein. Such platforms are offered by companies such as Wright Manufacturing (see, U.S. Pat. No. 6,059,055, the entire content of which is incorporated herein by reference). The invention is not entirely reliant upon products from any one manufacturer in particular, however, as the configurations described herein may be built without the benefit of pre-assembled powered platforms.

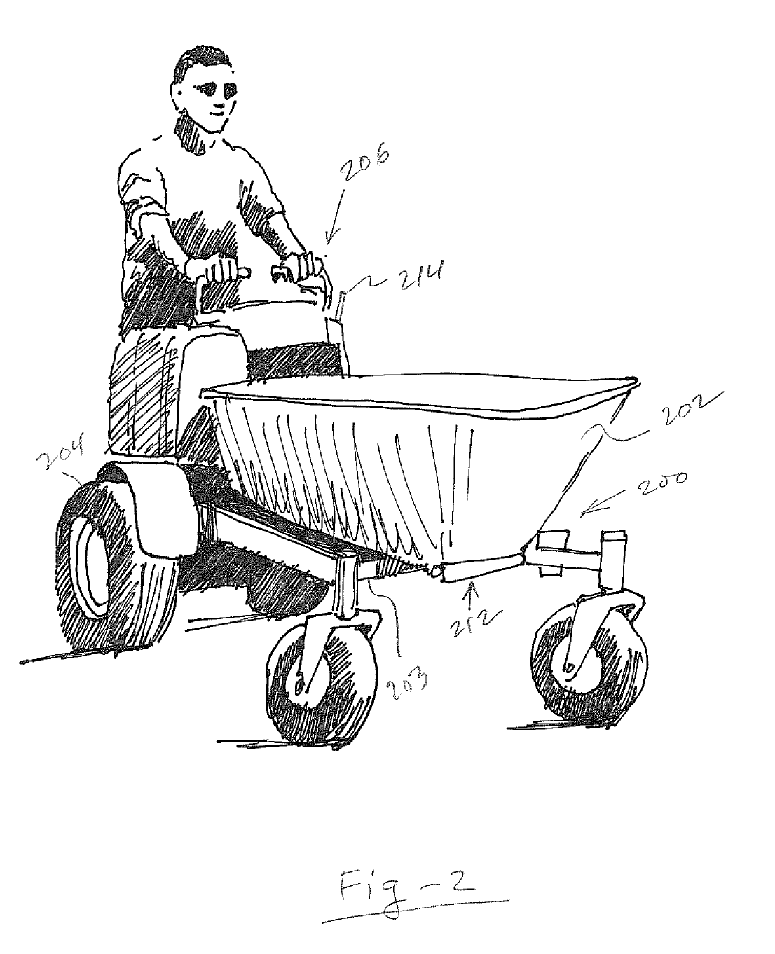

FIG. 2 illustrates a preferred embodiment of the invention in the form a stand-on power wheelbarrow fabricated by converting a Wright stand-on “Stander” mower. In particular, all mower-specific parts have been removed, including the mower deck, shroud and blade. As the front caster wheels are supported by the mower deck, these are temporarily removed as well. This leaves a frame 200 with rear wheels 204, drive mechanism with controls 206, and gas engine.

As part of the conversion, a plate 203 is mounted on the frame so that the front caster wheels 205 may be remounted. A bucket 202 has been mounted on the frame via hinge 212, with a control 214 being added to activate a mechanism to dump and retract the bucket.

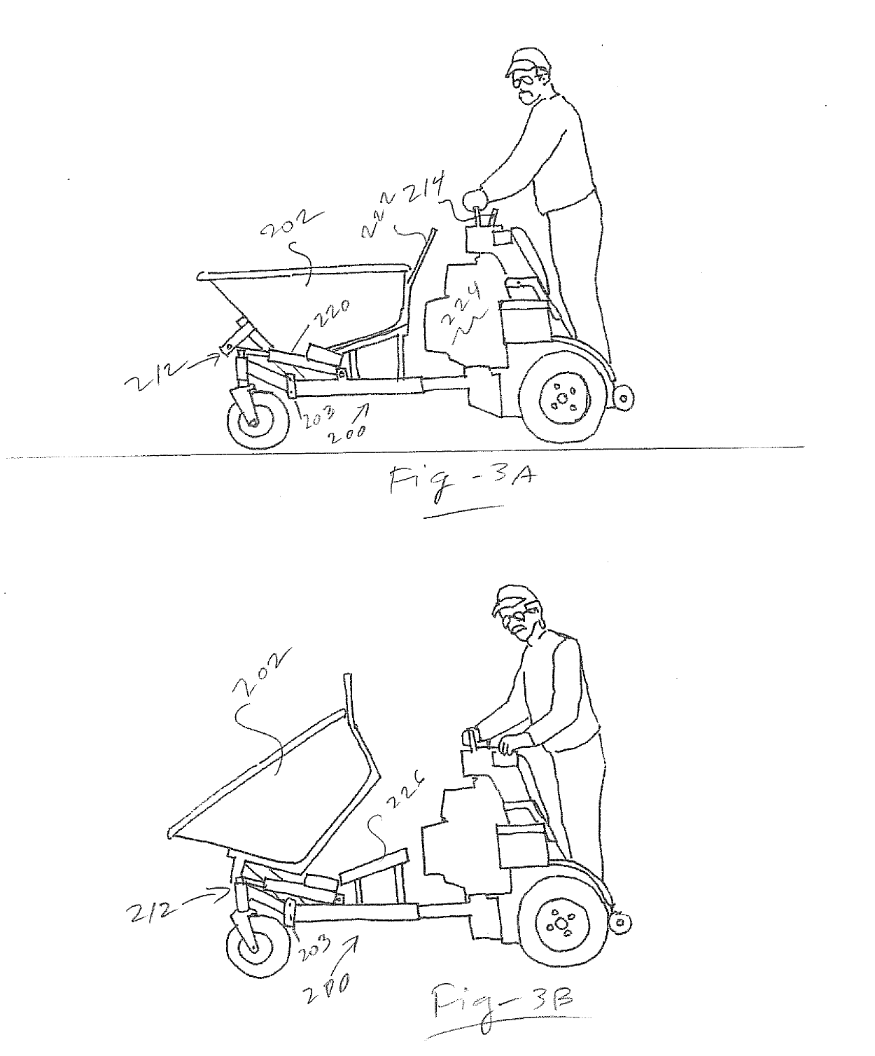

FIG. 3A shows the configuration of FIG. 2 with the bucket 202 in the non-dump position for motorized transport. Control 214 is used to actuate cylinder 220, both of which have been provided in accordance with the invention. In the preferred embodiment a single electrical cylinder (linear actuator) is used, through dual, opposing cylinders, including pneumatic or hydraulic cylinders are not precluded. A shield 222 has also been added according to the invention to ensure that debris is not transferred in and around the engine components 224 when the bucket 202 is filled.

FIG. 3B shown the bucket 202 in the dump position, having pivoted about hinge 212 through activation of control 214. FIG. 3B also shows dump bucket stop/support frame 226, welded or otherwise attached to frame 200 as part of the conversion process. The top of the bucket support frame 226 conforms to the bottom of bucket 202, in this case on an angle with respect to the frame 200. The bucket may be removably attached with pins, and a manually operated or power dump handle may be provided. While the platform and drive mechanisms are preferably constructed of metal, a metal or plastic removable bucket may be used.

Apart from the powered dump application, any one of a number of other application-specific accessories may be mounted to the basic stand-up drive platform, through appropriate mechanisms to exchange or replace these devices.

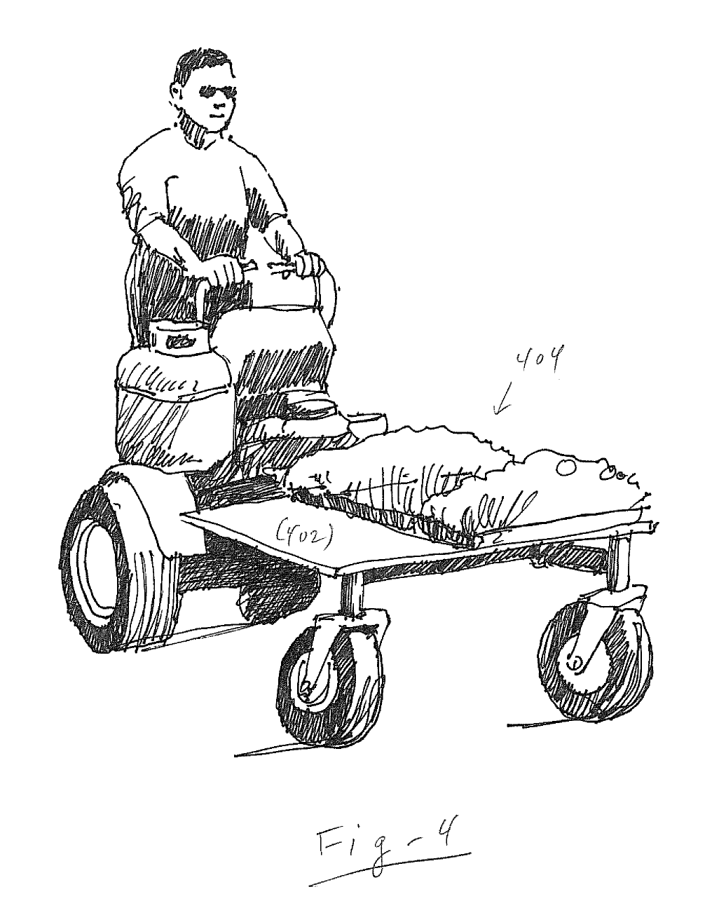

FIG. 4 illustrates a different application involving the same basic platform. In this embodiment, a flat bed 402 is provided to move bedding plants 404 or other materials in garden center or other environments.

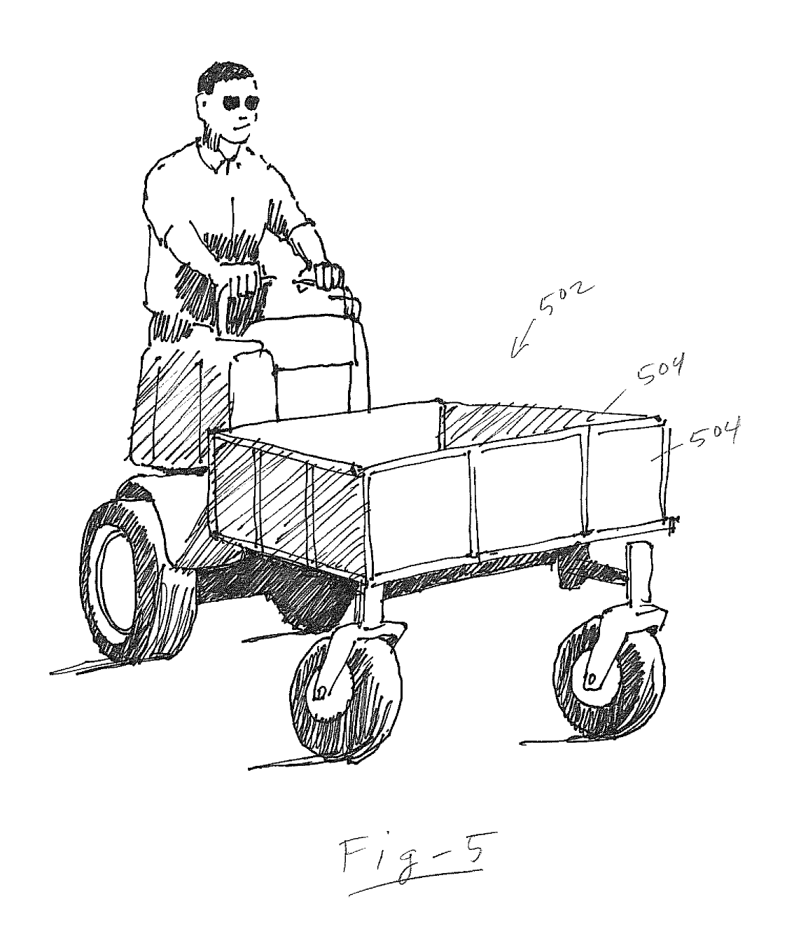

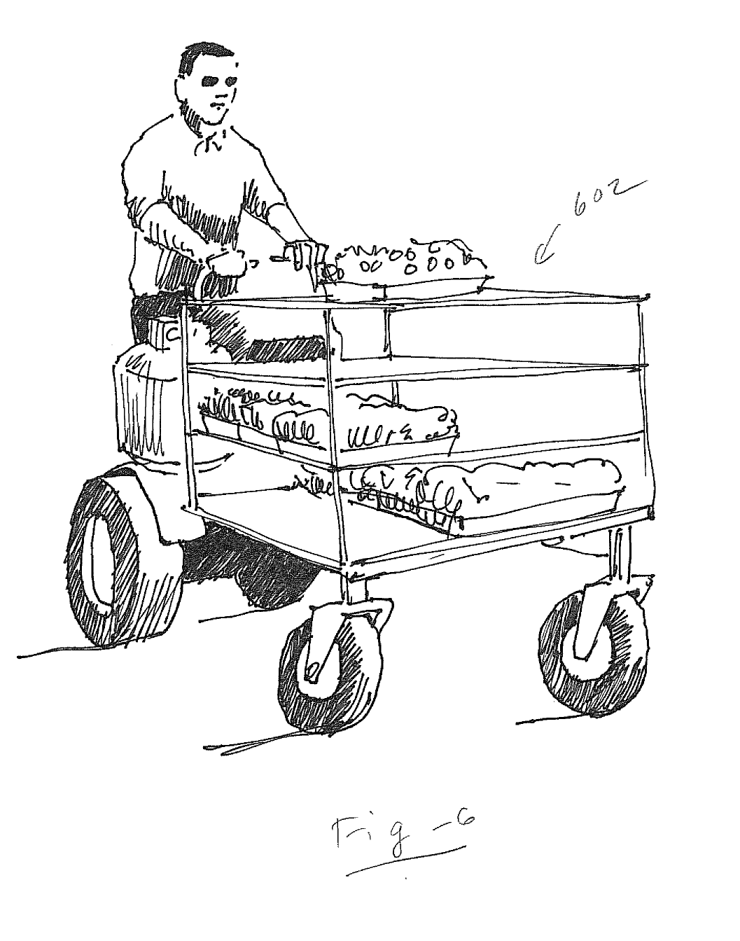

FIG. 5 shows a removable flat bed 502 with sides 504, which may also be removable. FIG. 6 shows a flat bed 602 with one or more rack portions.

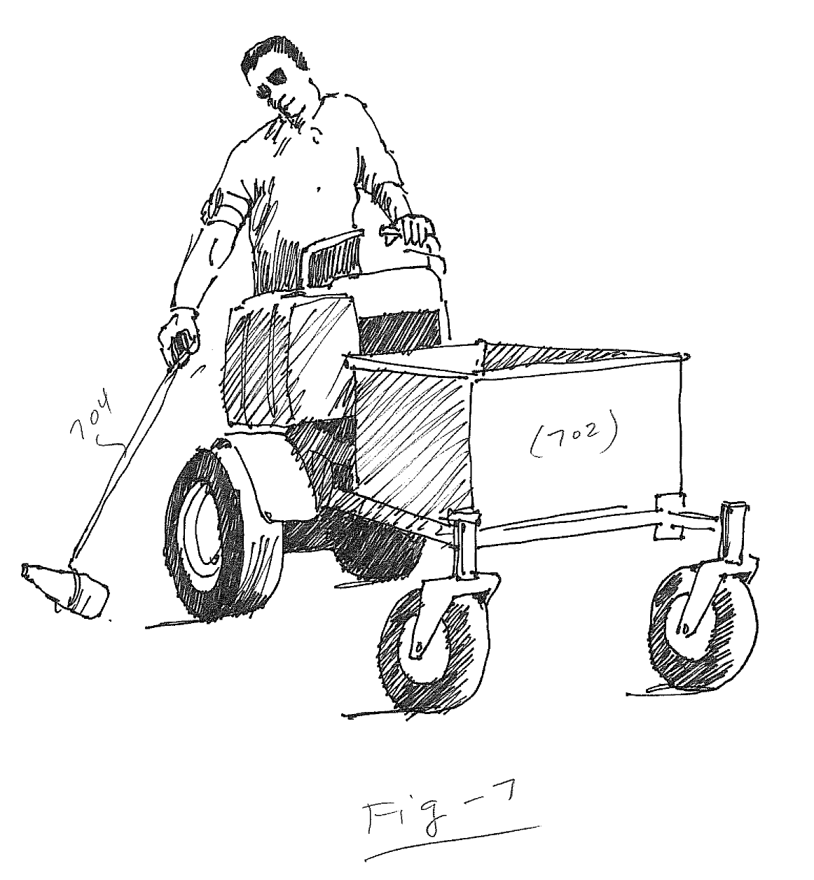

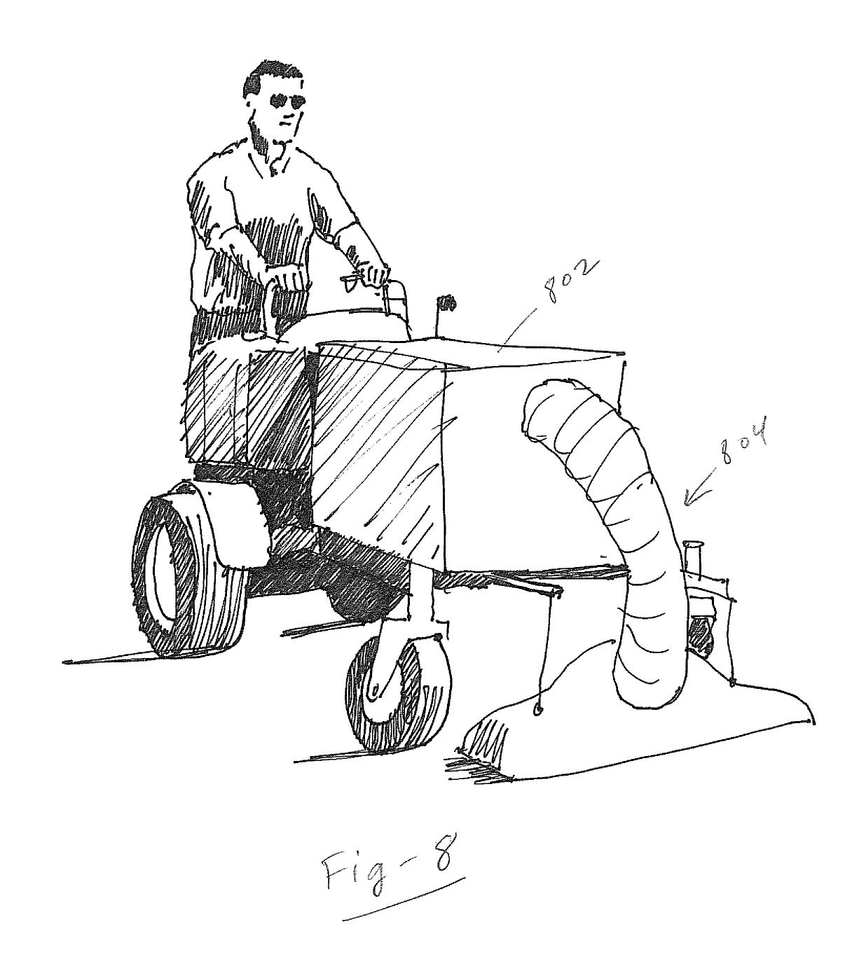

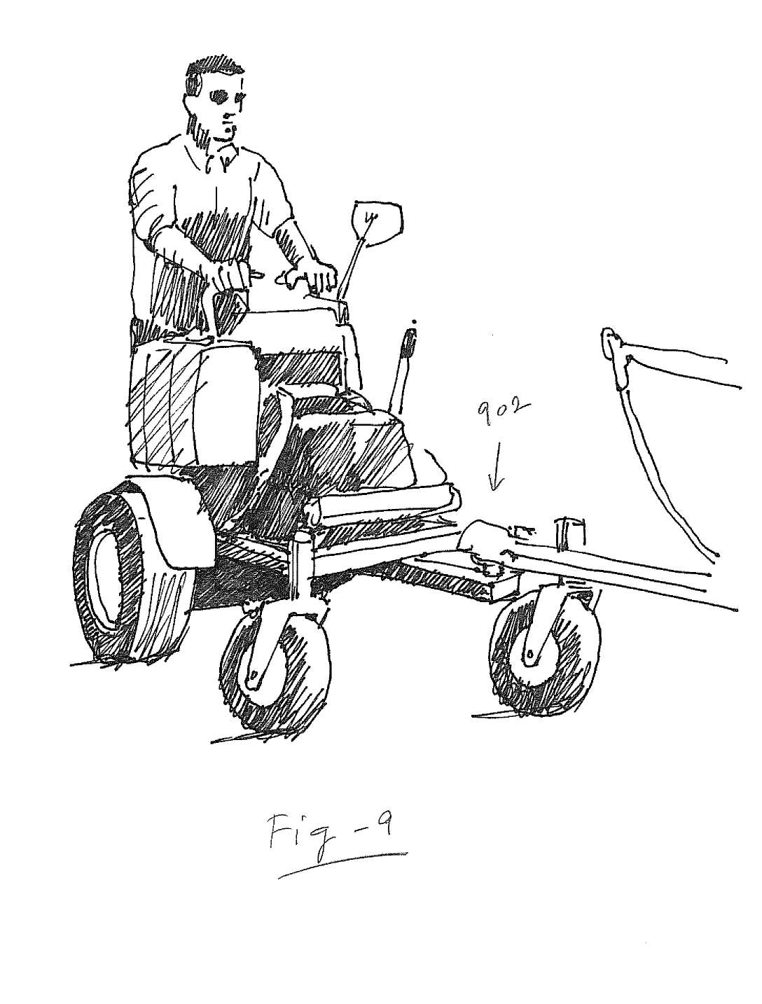

FIG. 7 illustrates a trash collection application including a square container 702, which may have an open or a closed top. The operator in this case is using a pickup device 704 to collect trash and place it into the container. FIG. 8 illustrates a vacuum embodiment of the invention including a suction head 804 feeding a collection box 802. FIG. 9 illustrates an embodiment wherein boats, trailers or other items attached to a tow hitch 902 may be moved with the stand-on platform.

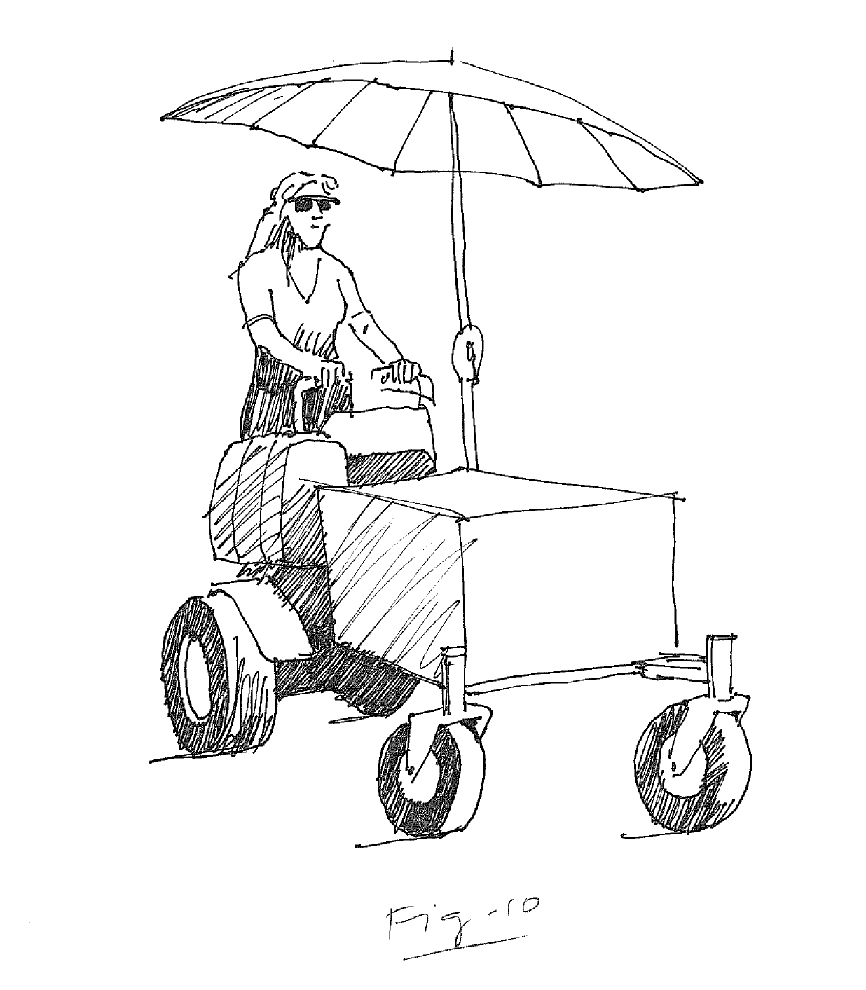

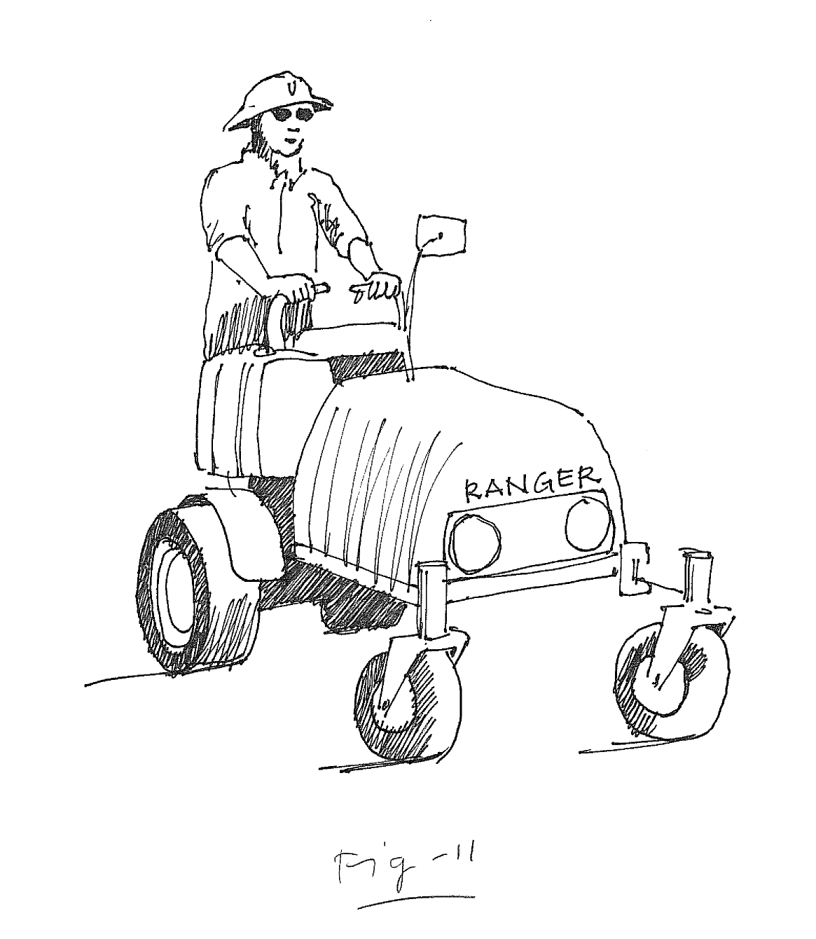

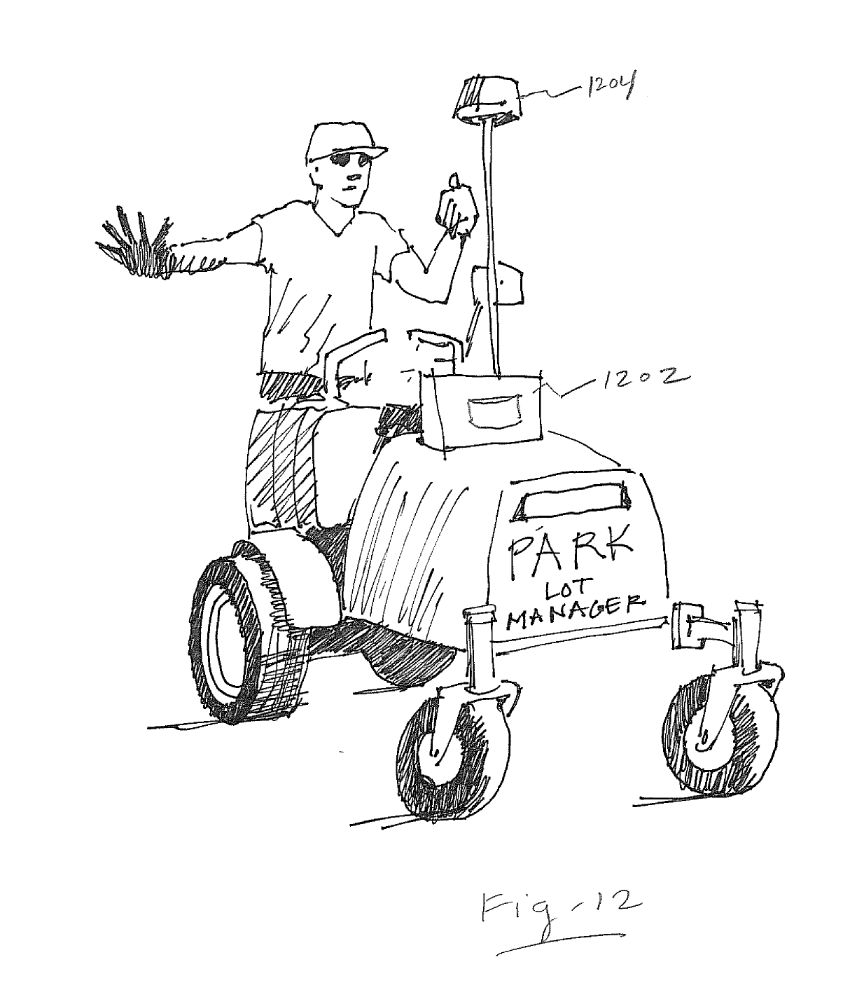

FIG. 10 illustrates a vending embodiment of the invention, for golf courses, fairs, parks and other environments. FIG. 11 illustrates a park ranger implementation, and FIG. 12 illustrates a parking lot management application with accessories such as cameras 1202, flashers 1204, and other items unique to this application.

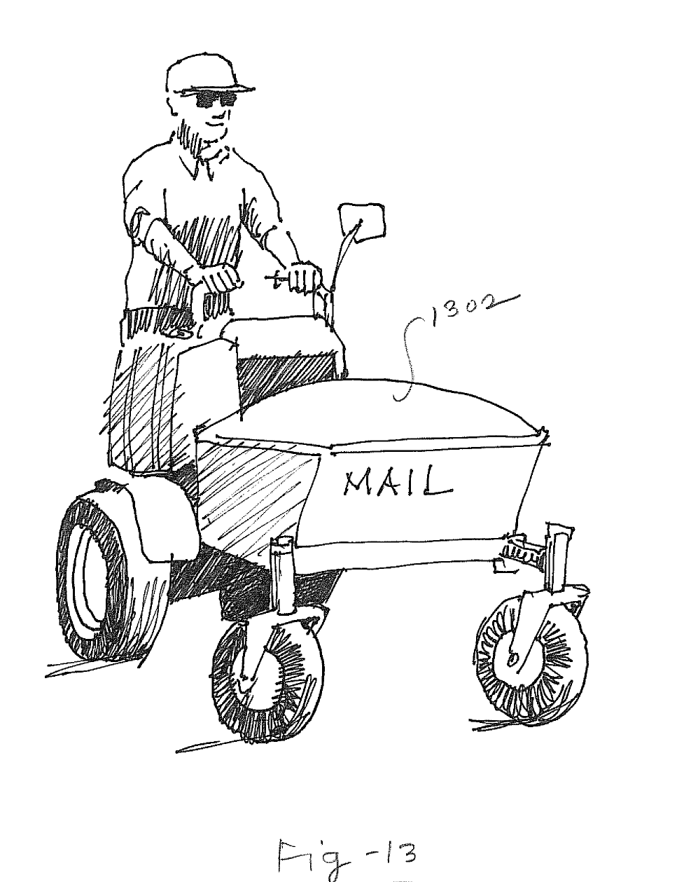

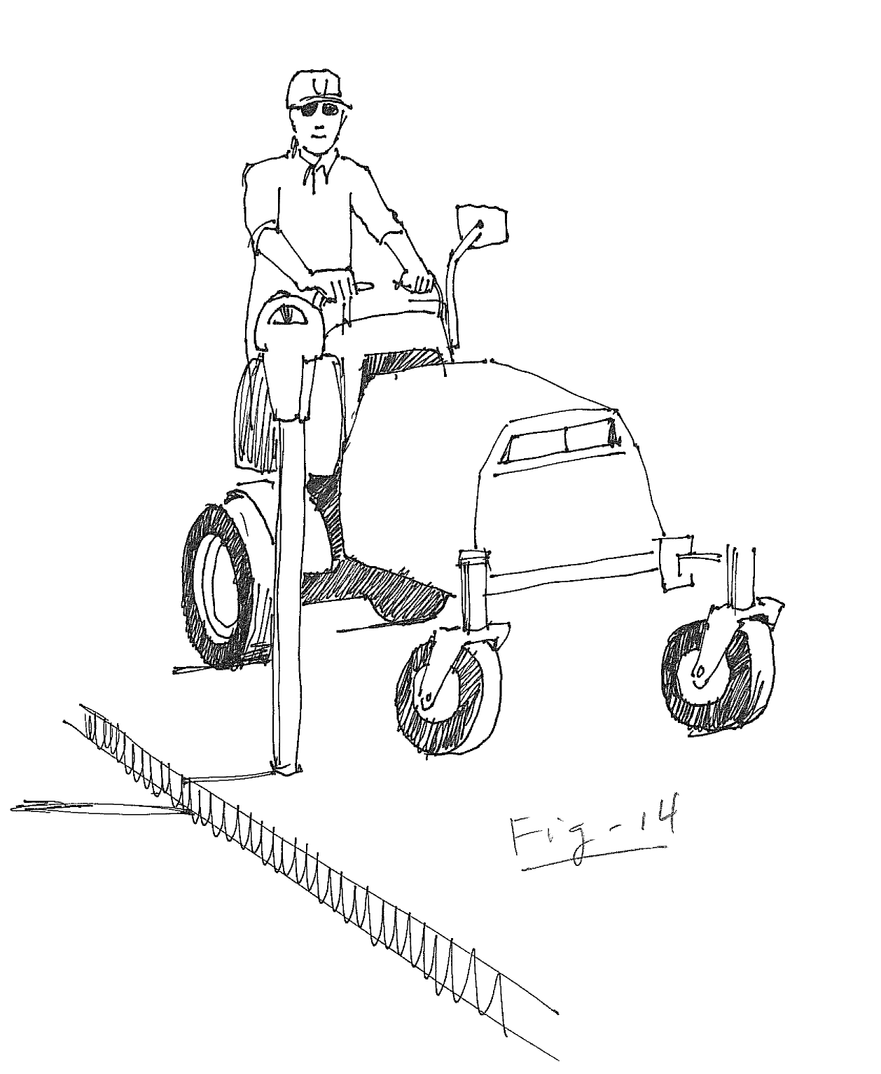

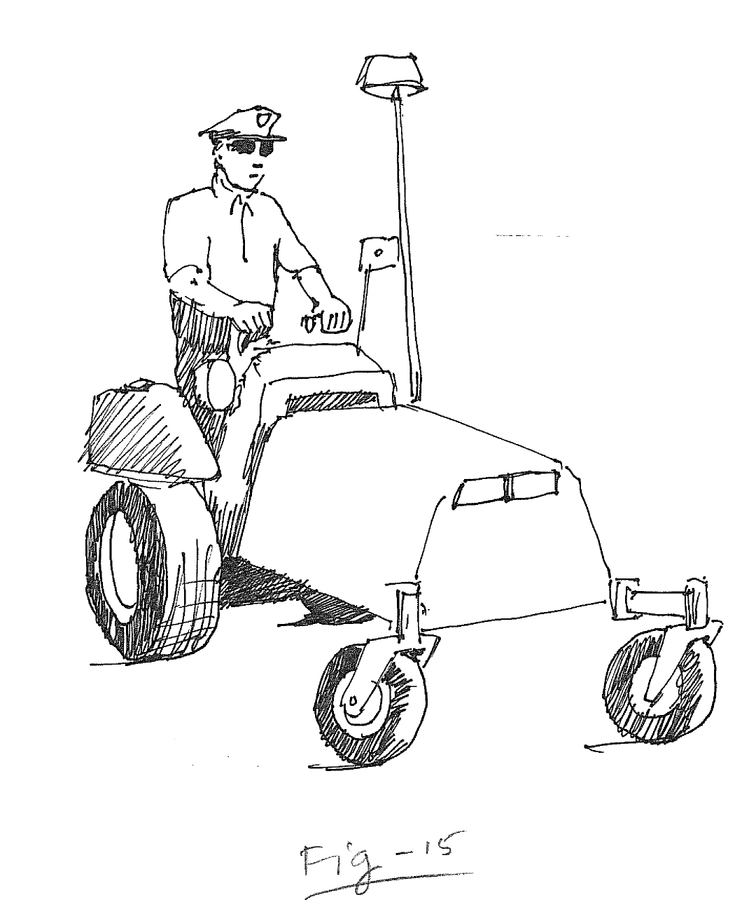

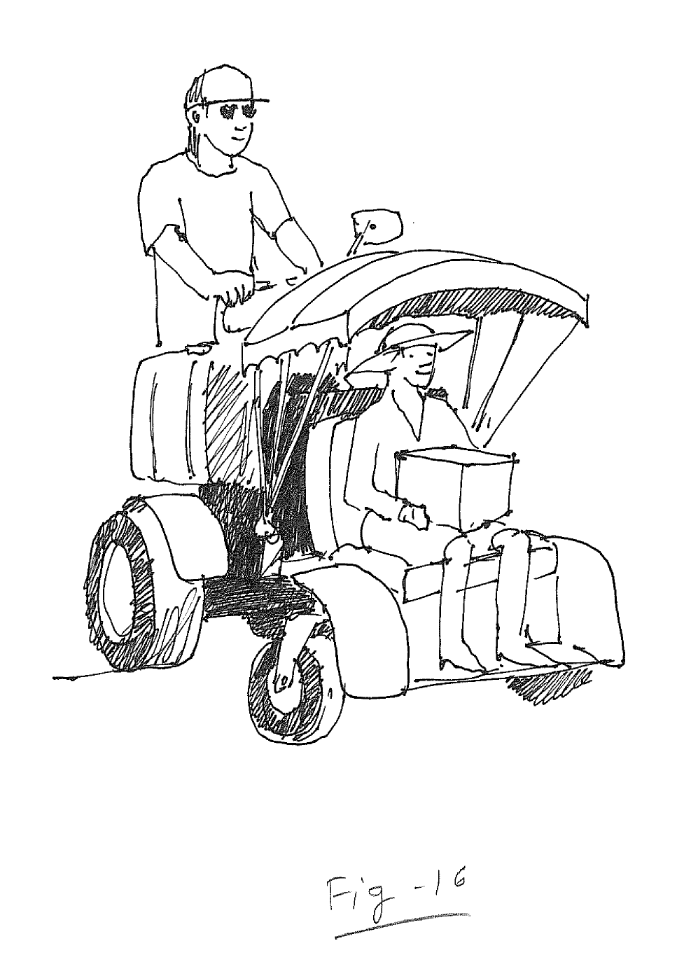

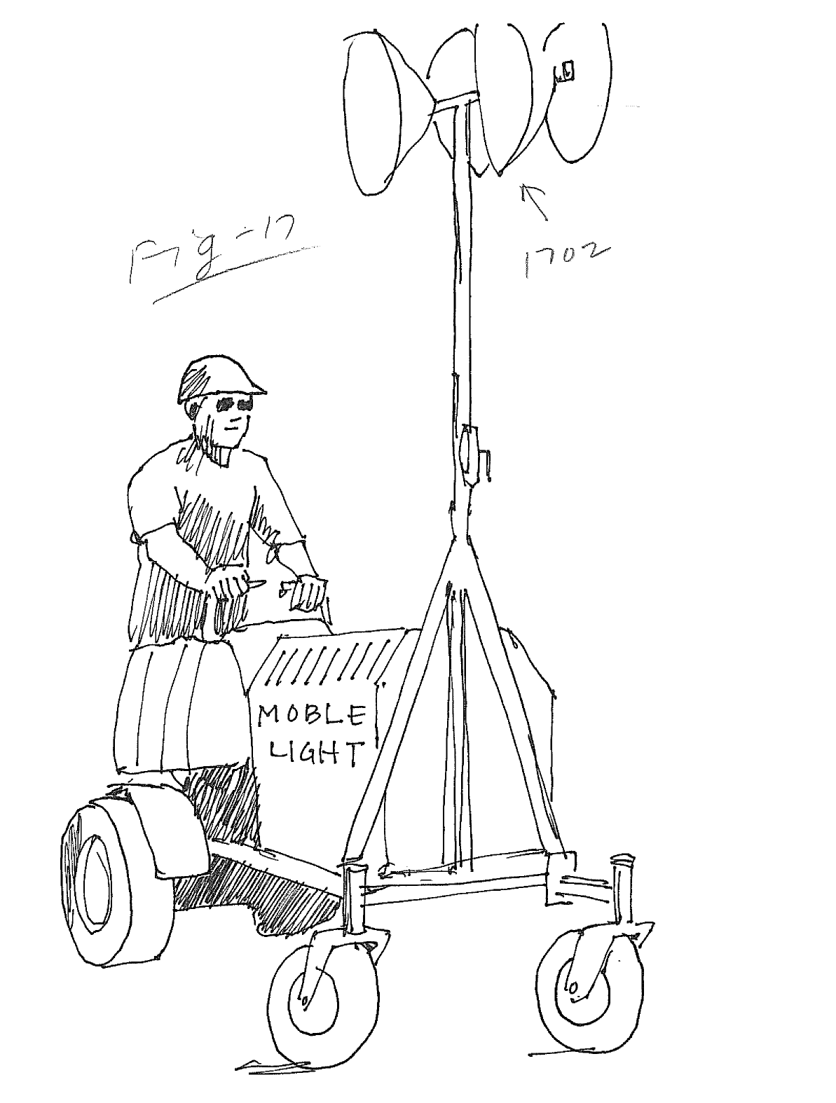

FIG. 13 illustrates a mail carrier for postal applications, with an optional transparent cover 1302. FIG. 14 illustrates a “meter maid” or other law-enforcement application, and FIG. 15 shows a higher level of security application, which may include flashers, mirrors, radios or other accessories. FIG. 16 shows a “rickshaw” application, and FIG. 17 illustrates a mobile light application, wherein the stand-on platform carries batteries or a fueled power unit to illuminate a portable light 1702.

In all of the embodiments described herein, various accessories may be included, depending upon the environment in which the invention is deployed. For example, hydraulics other than those provided for the basic drive mechanism may be utilized to move hinge portions, or raise/lower devices as necessary. Canopies other than those shown in the drawings may be provided along with windshields, more quiet mufflers, heat shields, power points, and so forth again, depending upon the application. Lights in various forms may be provided other than those shown, including spotlights, beacon flashers, radio/police lights, and so forth. The various embodiments may be outfitted with radios for music, earphones, headphone speakers, and the like. Mirrors other than those shown may further be provided.

Public address systems may be provided particularly in the security and law-enforcement applications and first aid kits may additionally be provided. Comfort features such as computer monitors, television monitors, and so forth may be used, along with cup holders and bottle holders. Different applications may employ metal detectors, or bullet-proof shields for “SWAT” applications. Water tanks may be provided for watering plants, animals or people, and such sources may include sprays for water, chemicals, fertilizers, paints, and the like. Certain applications may be outfitted with compressors to run machinery such as jackhammers, and so forth and holders may be provided for clipboards, mail bundles, white boards/chalkboards, and so forth.

Plows and/or blowers may be provided for leaves, snow, and the like and, in medical applications, drugs, defibrillators, blood pressure monitors, breathing apparatus and other accessories may be included. GPS electronics may be used to determine location, and breathalyzers may be provided, particularly in law-enforcement applications. A “glove box” may be used in any or all of the applications to house personal belongings, such as wallet, cell phone, binoculars, flashlights, keys, and the like.

I claim:

1. A method of converting a stand-on type lawn mower into a non-mower implement, comprising the steps of:
providing a stand-on type lawn mower having frame with a mower deck, engine, steering mechanism and steering controls;
removing the mower deck from the frame, leaving the engine, steering mechanism and steering controls substantially intact; and
mounting components to the frame enabling the implement to be used for a non-mower application.

2. The method of claim 1, including the steps of
mounting a dump bucket to the frame through a forward hinge; and
providing an actuator with a user-operated control, the actuator being operative to pivot the dump bucket between a non-dump position for loading and transport and a dump position wherein the bucket is lifted through the forward hinge for dumping purposes.

3. The method of claim 2, wherein the actuator is an electric linear actuator.

4. The method of claim 2, wherein the user-operated control is supported proximate to the steering controls.

5. The method of claim 2, wherein the dump bucket has a bottom with a contour, the method further including the step of mounting a bucket support frame on the frame, the bucket support frame having an upper surface that cooperates with the bottom contour of the dump bucket.

6. The method of claim 2, wherein the mower deck includes a pair of opposing caster wheels attached thereto, the method further comprising the steps of:
temporarily removing the caster wheels from the mower deck;
installing a mounting plate onto the frame once the mower deck is removed; and
mounting the caster wheels to the mounting plate.

7. The method of claim 2, further including the step of providing a debris shield on the dump bucket to protect the engine from contamination during bucket loading.
